(19) United States
(12) Patent Application Publication
(10) Pub. No.: US 2023/0109517 A1
(43) Pub. Date: Apr. 6, 2023

(54) DUAL-PORT SENSOR FOR VEHICLES

(71) Applicant: Huawei Technologies Co., Ltd., Shenzhen (CN)

(72) Inventor: Jinshui LIU, Plano, TX (US)

(73) Assignee: Huawei Technologies Co., Ltd., Shenzhen (CN)

(21) Appl. No.: 18/062,687

(22) Filed: Dec. 7, 2022

Related U.S. Application Data
(63) Continuation of application No. PCT/US2020/070176, filed on Jun. 24, 2020.

(51) Int. Cl. B60W 50/023; B60W 60/00; B60R 16/033

(52) U.S. Cl. CPC B60W 50/023; B60W 60/00; B60R 16/033; B60W 2420/42

(57) ABSTRACT

A sensor subsystem for vehicles, such as autonomous driving vehicles, has two network ports for which each network port is connectable to one of two in-vehicle computers (IVCs) for control, configuration, status and data transfers between the sensor subsystem and the two IVCs. The two IVCs can be structured as redundant IVCs. The sensor subsystem can replicate sensor data to the redundant IVCs. The sensor data can be raw image data, encoded image data, processed perception data, or a combination of the data. The two IVCs can be implemented with a modular design with each IVC disposed on a platform separate from the platform on which the second of the two redundant IVCs is disposed. The two IVCs can be replaced separately to reduce repair or replacement cost.

### CROSS-REFERENCE TO RELATED APPLICATIONS

This application is a continuation of International Application No. PCT/US2020/070176, filed on Jun. 24, 2020, entitled “DUAL-PORT SENSOR FOR VEHICLES,” the benefit of priority of which is claimed herein, and which application is hereby incorporated herein by reference in its entirety.

### TECHNICAL FIELD

The present disclosure is related to sensors for vehicles and, in particular, to dual-port sensor designs for autonomous driving vehicles.

### BACKGROUND

In the last several years, due to the maturity and advancement of deep learning, such as deep neural networks (DNNs), and artificial intelligence technologies, autonomous driving vehicle technologies and associated markets have seen exceptional interest. Market research has indicated that autonomous driving vehicle technologies and associated technologies can grow to a trillion dollar market by 2040. Several levels of driving automation have been defined. The Society of Automotive Engineers (SAE) J3016 standard classifies the levels of driving automation into Level 0 to Level 5 with Level 4 and Level 5 as autonomous driving, Level 0 to Level 2 as assisted driving, and Level 3 as limited autonomous driving.

For autonomous driving, an in-vehicle computer (IVC) receives and processes perception data from different sensors including combinations of a camera sensor, a radar sensor, a light detection and ranging (LiDAR) sensor, a sonar sensor, an inertial measurement unit (IMU) sensor, and a global positioning system (GPS) receiver sensor. Perception data is data regarding the state of being or process of becoming aware of a specified environment through sensory-like data. The IVC can make driving control decisions based on a processed perception data result from the perception data from the different sensors. The driving control decisions can be directed to vehicle instrumentality preforming functions of steering, braking, speed control, acceleration, and engine control.

As the IVC makes all the driving control decisions for the Level 4 and Level 5 autonomous driving vehicle without human intervention, reliable and redundant IVCs are used so that the vehicle will continue operating normally in case of one IVC failure. Designs and techniques to provide further reliability can enhance autonomous driving vehicle technologies and associated market.

### SUMMARY

It is an object of various embodiments to provide an efficient architecture for a sensor design for autonomous vehicles. The various embodiments can include redundant in-vehicle computers with a modular design methodology to reduce repair or replacement cost. A sensor design for vehicles, such as autonomous vehicles, has two ports with each port connected to one of two in-vehicle computers for control, configuration, status and data transfers between the sensor and the two in-vehicle computers. The two ports of the sensor can be two Ethernet ports. The sensor can replicate sensor data to the two in-vehicle computers, structured as redundant in-vehicle computers, on-demand from one or both of the in-vehicle computers. The sensor data being replicated can be raw data, encoded data, processed perception data, or any combination of data. The in-vehicle computer system can adopt a modular design with each in-vehicle computer on a separate platform, which allows for the in-vehicle computers to be replaced separately, which can reduce repair or replacement cost significantly. The Summary is not intended to identify key or essential features of the claimed subject matter, nor is it intended to be used to limit the scope of the claimed subject matter.

According to a first aspect of the present disclosure, there is provided a system for a vehicle. The system includes a sensor subsystem capable of being arranged in a vehicle. A first port of the sensor subsystem is structured to couple to a first in-vehicle computer, with the sensor subsystem separate from a first enclosure of the first in-vehicle computer. A second port of the sensor subsystem is structured to couple to a second in-vehicle computer, with the sensor subsystem separate from a second enclosure of the second in-vehicle computer.

In a first implementation form of the system according to the first aspect as such, the first port and the second port are coupled to a dual-pair connector of the sensor subsystem with the dual-pair connector to couple to the first in-vehicle computer and to the second in-vehicle computer.

In a second implementation form of the system according to the first aspect as such or any preceding implementation form of the first aspect, the sensor subsystem is a camera subsystem including: a lens; a sensor coupled to the lens to capture an image; and a controller coupled to receive image data from the sensor and provide a version of the image data to the first port and to the second port.

In a third implementation form of the system according to the first aspect as such or any preceding implementation form of the first aspect, the version of the image data includes raw image data, encoded image data, processed perception data, or a combination of raw image data, encoded image data, and processed perception data.

In a fourth implementation form of the system according to the first aspect as such or any preceding implementation form of the first aspect, the version of the image data is provided to the first port and to the second port in response to an instruction received from the first in-vehicle computer or the second in-vehicle computer.

In a fifth implementation form of the system according to the first aspect as such or any preceding implementation form of the first aspect, the first port and the second port are twisted-pair single-pair Ethernet (SPE) ports. The first port is structured to connect to the first in-vehicle computer to provide communication of control, configuration, status, and data transfers between the sensor subsystem and the first in-vehicle computer. The second port is structured to connect to the second in-vehicle computer to provide communication of control, configuration, status, and data transfers between the sensor subsystem and the second in-vehicle computer.

In a sixth implementation form of the system according to the first aspect as such or any preceding implementation form of the first aspect, each of the first port and the second port is structured to connect to a SPE link with Power-over-Data-Line support.

In a seventh implementation form of the system according to the first aspect as such or any preceding implementation form of the first aspect, the system includes: the first in-vehicle computer having a first cable connector to couple to the first port; and the second in-vehicle computer having a second cable connector to couple to the second port.

According to a second aspect of the present disclosure, there is provided a system for a vehicle. The system includes a sensor subsystem, a first in-vehicle computer, and a second in-vehicle computer. The sensor subsystem has a first port and a second port. The first in-vehicle computer is coupled to the first port with the first in-vehicle computer disposed on a first circuit board. The second in-vehicle computer is coupled to the second port with the second in-vehicle computer disposed on a second circuit board, the first circuit board being separate from the second circuit board.

In a first implementation form of the system according to the second aspect as such, the system includes a communication link between the first in-vehicle computer and the second in-vehicle computer.

In a second implementation form of the system according to the second aspect as such or any preceding implementation form of the second aspect, the system includes an enclosure housing the first in-vehicle computer and the second in-vehicle computer, with power distributed to the first in-vehicle computer and the second in-vehicle computer via a backplane connectable to a battery system of a vehicle.

In a third implementation form of the system according to the second aspect as such or any preceding implementation form of the second aspect, the system includes a dual-pair connector of the sensor subsystem containing the first port and the second port, and a splitter cable coupled to the dual-pair connector, to a first connector of the first in-vehicle computer; and to a second connector of the second in-vehicle computer.

In a fourth implementation form of the system according to the second aspect as such or any preceding implementation form of the second aspect, the first port and the second port are twisted-pair single-port Ethernet ports. The first port is structured to connect to the first in-vehicle computer to provide communication of control, configuration, status, and data transfers between the sensor subsystem and the first in-vehicle computer. The second port is structured to connect to the second in-vehicle computer to provide communication of control, configuration, status, and data transfers between the sensor subsystem and the second in-vehicle computer.

In a fifth implementation form of the system according to the second aspect as such or any preceding implementation form of the second aspect, the sensor subsystem is one of a camera subsystem, a radar subsystem, a lidar subsystem, a sonar subsystem, a global positioning subsystem, an inertial measurement unit subsystem, and a subsystem of a combination of a camera sensor, a radar sensor, a lidar sensor, a sonar sensor, a global positioning sensor, and an inertial measurement sensor on a same package.

In a sixth implementation form of the system according to the second aspect as such or any preceding implementation form of the second aspect, the first in-vehicle computer is coupled to first ports of one or more additional sensor subsystems and the second in-vehicle computer is coupled to second ports of the one or more additional sensor subsystems.

In a seventh implementation form of the system according to the second aspect as such or any preceding implementation form of the second aspect, each of the first in-vehicle computer and the second in-vehicle computer includes a memory storing instructions and data, and one or more processors in communication with the memory, wherein the one or more processors execute the instructions to control an autonomous vehicle.

In an eighth implementation form of the system according to the second aspect as such or any preceding implementation form of the second aspect, the system is an autonomous vehicle.

According to a third aspect of the present disclosure, there is provided a method of operating a vehicle. The method includes generating sensor data using a sensor subsystem arranged in a vehicle and providing, from the sensor subsystem, a version of the sensor data to a first port of the sensor subsystem and to a second port of the sensor subsystem. The version of the sensor data is received at a first in-vehicle computer coupled to the first port and at a second in-vehicle computer coupled to the second port. Stored instructions associated with the received version of the sensor data are executed using a processor of the first in-vehicle computer or the second in-vehicle computer. The vehicle is controlled from executing the stored instructions associated with the received version of the sensor data.

In a first implementation form of the method according to the third aspect as such, the method includes providing power to the sensor subsystem via a splitter cable coupling a connector of the first in-vehicle computer and a connector of the second in-vehicle computer to a dual-pair connector containing the first port and the second port. The splitter cable and the sensor subsystem are operable with Power-over-Data-Line (PoDL) support.

In a second implementation form of the method according to the third aspect as such, the first in-vehicle computer and the second in-vehicle computer are replaceable independent of each other.

Any one of the foregoing examples may be combined with any one or more of the other foregoing examples to create a new embodiment within the scope of the present disclosure.

### BRIEF DESCRIPTION OF THE DRAWINGS

The drawings, which are not necessarily drawn to scale, illustrate generally, by way of example, but not by way of limitation, various embodiments discussed in the present document.

FIG. 1 illustrates an example system for a vehicle, according to various example embodiments.

FIG. 2 illustrates an example sensor subsystem coupled to both a first in-vehicle computer and a second in-vehicle computer, according to various example embodiments.

FIG. 3 illustrates an example of multiple sensor subsystems coupled to both a first in-vehicle computer and a second in-vehicle computer, according to various example embodiments.

FIG. 4 illustrates an example of a first in-vehicle computer and a second in-vehicle computer arranged to receive power from a battery system, according to various example embodiments.

FIG. 5 illustrates an example of a first in-vehicle computer and a second in-vehicle computer arranged to receive power from a battery system, according to various example embodiments.

FIG. 6 illustrates an example sensor subsystem configured with a first in-vehicle computer and a second in-vehicle computer arranged to receive power from a battery system, according to various example embodiments.

FIG. 7 illustrates an example sensor subsystem configured with a first in-vehicle computer and a second in-vehicle computer arranged to receive power from a battery system, according to various example embodiments.

FIG. 8 illustrates an example camera subsystem configured with a first in-vehicle computer and a second in-vehicle computer, according to various example embodiments.

FIG. 9 illustrates an example in-vehicle computer structure that can be used for two redundant in-vehicle computers to couple to sensor subsystems, according to various example embodiments.

FIG. 10 is a block diagram of an example first in-vehicle computer of a pair of redundant in-vehicle computers, illustrating functionality of the in-vehicle computers implemented in an autonomous vehicle, according to various example embodiments.

FIG. 11 is a flow diagram of features of an example method of operating a vehicle, according to various example embodiments

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized, and that structural, logical, mechanical, and electrical changes may be made. The following description of example embodiments is, therefore, not to be taken in a limited sense.

The functions or algorithms described herein may be implemented in software in an embodiment. The software may comprise computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, application-specific integrated circuit (ASIC), a microprocessor, or other type of processor operating on a computer system, such as a personal computer, server or other computer system, turning such computer system into a specifically programmed machine.

Computer-readable non-transitory media includes all types of computer readable media, including magnetic storage media, optical storage media, and solid state storage media and specifically excludes signals. It should be understood that the software can be installed in and sold with the devices that handle data analysis, mapping and path planning, and control of functions associated with an autonomous driving vehicle. Alternatively, the software can be obtained and loaded into such devices, including obtaining the software via a disc medium or from any manner of network or distribution system, including, for example, from a server owned by the software creator or from a server not owned but used by the software creator. The software can be stored on a server for distribution over the Internet, for example.

For autonomous driving, the IVC performs functions of perception processing, mapping, path planning and vehicle controls. For L4 and L5 autonomous driving, the IVC makes almost all of the driving decisions, thus two redundant IVCs are used to provide robotic and autonomous systems (RAS) features. Current IVC system designs place two redundant IVCs on the same printed circuit board (PCB). In addition, each of the current sensors, providing the perception data to the IVCs, use one network port to connect to the two redundant IVCs in three possible arrangements. The network port type between the IVCs and a sensor can be, depending on the sensor, a controller area network (CAN) bus, FlexRay™, Mobile Industry Processor Interface (MIPI) camera serial interface (CSI) over low-voltage differential signaling (LVDS), or Ethernet. FlexRay™ is an automotive network communications protocol developed by the FlexRay Consortium to govern on-board automotive computing. MIPI CSI is a specification of the MIPI Alliance. LVDS is a digital interface used for many applications that demand low power consumption and relatively high noise immunity for relatively high data rates. Ethernet is a technology for connecting to wired local area networks (LANs) and enables a device to communicate with other devices through a common protocol. Examples of these sensors include a multi-function stereo camera, a multi-function mono camera, a multi-function camera with LiDAR, other multi-purpose cameras, an infrared LiDAR sensor, and a radar system. In some cases, one sensor subsystem may integrate two or more sensors on the same mechanical package. For example, two CMOS (complementary metal-oxide-semiconductor) image sensors or one CMOS image sensor plus one LiDAR or radar sensor, can have two or more network ports with each of the network ports connected to one sensor. However, in this case, there is still a single network port sensor, as the same sensor is only connected to one IVC.

The three current possible arrangements using one network port to connect to two redundant IVCs include: data from a sensor being replicated to provide the data to the two redundant IVCs via a splitter or a switch; data from a sensor being replicated to provide the data to the two redundant IVCs via separate signal drivers; and data from a sensor being replicated to provide the data to the two redundant IVCs via one of the two IVCs being a primary IVC that replicates the data and sends the replicated data to the second of the two IVCs. In these arrangements, the one network port can connect to the two redundant IVCs via a Ethernet, CSI, or CAN link.

The splitter or switch arrangement to provide data from the sensor to the two redundant IVCs can be a single-point of failure. Failure of the splitter or the switch can be costly as it can lead to whole IVC system replacement. The whole IVC system replacement results from the two redundant IVCs and the splitter or switch being arranged on a common platform such as one PCB or one baseboard.

The separate signal drivers arrangement to provide data from the sensor to the two redundant IVCs can be subject to high-speed signal integrity of a serializer/deserializer (SerDes) used in the signal drivers as a point of failure. A SerDes compensates for limited input/output and is implemented as a pair of functional blocks to convert data between serial data and parallel interfaces in each direction. Failure of the separate signal drivers arrangement can be costly as it can lead to whole IVC system replacement. The whole IVC system replacement results from the two redundant IVCs and the separate signal drivers arranged on a common platform such as one PCB or one baseboard.

The primary IVC to provide data from the sensor to the secondary IVC can be a single-point of failure. The data can be provided from the primary IVC to the secondary IVC using a data replication link that can also be a point of failure. Failure of the primary IVC can be costly as it can lead to whole IVC system replacement. The whole IVC system replacement results from the two redundant IVCs and the data replication link arranged on a common platform such as one PCB or one baseboard. The primary IVC arrangement can also be accompanied by heavy inter-IVC traffic relay, which can incur, among other things, delay.

These three current possible arrangements for a sensor and redundant IVCs demonstrate drawbacks of using single network port sensors with two redundant IVCs that are disposed on the same PCB. As noted, these drawbacks include costly IVC system replacement in case of one IVC failure, a single point failure of a primary IVC, heavy inter-IVC data relay, splitter/switch component reliability dependence, or a signal integrity challenge associated with high speed SerDes.

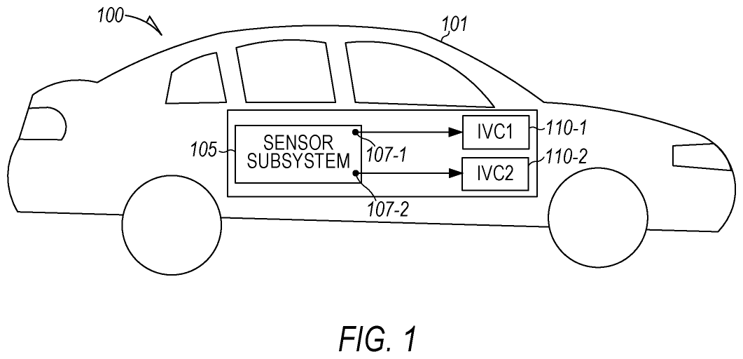

FIG. 1 illustrates an embodiment of an example system 100 for a vehicle 101. System 100 can include a sensor subsystem 105, a first IVC 110-1, and a second IVC 110-2 such that the sensor subsystem 105 is capable of being arranged in the vehicle 101 along with the first IVC 110-1 and the second IVC 110-2. The vehicle 101 can be an autonomous driving vehicle. A first port 107-1 of the sensor subsystem 105 can be structured to couple to the first IVC 110-1. A second port 107-2 of the sensor subsystem 105 can be structured to couple to the second IVC 110-2. The sensor subsystem 105 can be separate from a first enclosure containing the first IVC 110-1 and separate from a second enclosure containing the second IVC 110-2. Alternatively, the first IVC 110-1 and the second IVC 110-1 can be contained in a common enclosure on a common platform such as a common PCB. In another arrangement, the first IVC 110-1 and the second IVC 110-1 can be contained in a common enclosure on separate platforms such as separate PCBs. The first IVC 110-1 and the second IVC 110-1 can be structured as redundant IVCs. An inter-IVC communication link can be provided between the first IVC 110-1 and the second IVC 110-1.

The first port 107-1 and the second port 107-2 can be structured in a number of arrangements. The first port 107-1 and the second port 107-2 can be coupled to a dual-pair connector of the sensor subsystem 105 with the dual-pair connector to couple to the first IVC 110-1 and to the second IVC 110-2. The first port 107-1 and the second port 107-2 can be implemented as twisted-pair single-pair Ethernet (SPE) ports. The first port 107-1 can be structured to connect to the first IVC 110-1 to provide communication of control, configuration, status, and data transfers between the sensor subsystem 105 and the first IVC 110-1. The second port 107-2 can be structured to connect to the second IVC 110-2 to provide communication of control, configuration, status, and data transfers between the sensor subsystem 105 and the second IVC 110-2. The first port 107-1 and the second port 107-2 can be structured on the sensor subsystem 105 as two network ports that share a same dual-pair connector defined by IEEE 802.3 Ethernet standard organization and the automotive industry, and can use twisted-pair single-pair Ethernet technologies as defined in IEEE 802.3bw or 802.3 bp or 802.3ch for communications with the IVCs 110-1 and 110-2. Each of the first port 107-1 and the second port 107-2 can be structured to connect to a single-pair Ethernet link with Power-over-Data-Line (PoDL) support, which usage can be defined in IEEE 802.3bu to deliver supply of power to the sensor subsystem 105 from the respective IVCs 110-1 and 110-2. The IEEE 802.3 group has defined the 100Base-T1 (via IEEE 802.3bw) and the 1000Base-T1 (via 802.3 bp) standard for support of 100 Mbps and 1 Gbps over a single-pair automotive cable and IEEE 802.3bu has defined PoDL for delivering power with 100Base-T1 and 1000Base-T1. The IEEE 802.3 group is also defining the IEEE 802,3ch standard for support of 2.5 Gbps, 5 Gbps and 10 Gbps over a single-pair automotive cable up to 15 meters with optional PoDL support.

The sensor subsystem 105 can be implemented as a camera subsystem, a radar subsystem, a lidar subsystem, a sonar subsystem, a global positioning subsystem, an inertial measurement unit subsystem, or a subsystem of a combination of these subsystems or additional subsystems. Such a combination of subsystems can be incorporated on a same package. The data provided by the sensor subsystem 105 to the first IVC and to the second IVC 110-2 can be raw data, encoded data, processed perception data, or any combination of data. Raw data, in general, is data that has been measured or sensed and collected directly from a source instrument and that has not been processed for use, while processed data is a type of data that is processed from raw data and converted into a format that can be analyzed or visualized. Encoded data is data that is converted into a different format than a given format in which the data is presented for the encoding process such as converting a given sequence of characters, symbols, alphabets etc., into a specified format. Data can be encoded for secure transmission of the data or for efficiency of transmission or storage of the data. Processed perception data is perception data that has been processed for a particular use such as converted into a format that can be analyzed or visualized, for example but not limited to, an recognized object such as “a car at coordinates of X and Y”, “a pedestrian at coordinates of X and Y”, “a stop sign at coordinates of X and Y”, based on artificial intelligence technologies such as but not limited to deep learning neural network inferencing.

The sensor subsystem 105 can be configured and controlled by either of the two IVCs 110-1 and 110-2 via commands over network links, and can transfer sensor perception data and sensor status to either of the two IVCs 110-1 an 110-2 under the control of the IVCs 110-1 and 110-2. The sensor subsystem 105 can provide the data to the two in-vehicle computers IVC 110-1 and 110-2 on-demand from one or both of the in-vehicle computers. The sensor subsystem 105 can provide the data to the two in-vehicle computers IVC 110-1 and 110-2 on a scheduled basis such as but not limited to a periodic transmission of data. The sensor subsystem 105 can provide the data to the IVCs 110-1 and 110-2 on demand or on a scheduled basis, with the vehicle 101 in an on-status. The sensor subsystem 105 can provide the data to the IVCs 110-1 and 110-2 continuously, with the vehicle 101 in an on-status. The frequency of data transmission to the IVCs 110-1 and 110-2 may depend on the type of sensor subsystem.

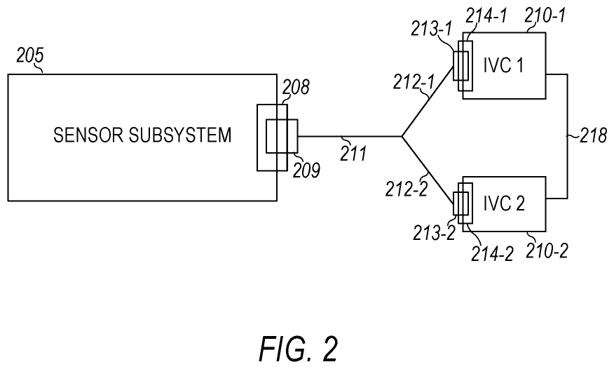

FIG. 2 illustrates an embodiment of an example sensor subsystem 205 coupled to both a first IVC 210-1 and a second IVC 210-2. The sensor subsystem 205, the first IVC 210-1, and the second IVC 210-2 can be implemented in a manner similar to the sensor subsystem 105 and IVCs 110-1 and 110-2 of FIG. 1. The sensor subsystem 205 can couple to both the first IVC 210-1 and the second IVC 210-2 via a cable 211. The first IVC 210-1 and the second IVC 210-2 can be structured as redundant IVCs. An inter-IVC communication link 218 can be provided between the first IVC 210-1 and the second IVC 210-2.

The cable 211 can be a splitter twisted-pair cable. A splitter twisted-pair cable can be structured as a cable containing multiple twisted pairs and having a single connector at a first end of the cable and multiple connectors at a second end of the cable opposite the first end. The single connector of the splitter twisted-pair cable at the first end can mate to a first connector to couple the multiple twisted pairs to ports associated with the first connector. Each connector of the multiple connectors of the splitter twisted-pair cable at the second end can mate to an individual connector to couple a twisted pair of the multiple twisted pairs to ports associated with the individual connector. The cable 211 can be dual-pair twisted-pair cable.

The cable 211 can have a dual-pair mating connector 209 to mate with a dual pair connector 208 on the sensor subsystem 205. The cable 211 can have a single-pair mating connector 213-1 that connects to a single-pair connector 214-1 on the first IVC 210-1. The single-pair connector 214-1 of the first IVC 210-1 couples the first IVC 210-1 to a first port of sensor subsystem 205 in pair connector 208 such that a twisted pair 212-1 couples to the first IVC 210-1 from the first port. The cable 211 can also have a single-pair mating connector 213-2 that connects to a single-pair connector 214-2 on the second IVC 210-2. The single-pair connector 214-2 of the second IVC 210-2 couples the second IVC 210-2 to a second port of sensor subsystem 205 in pair connector 208 such that a twisted pair 212-2 couples to the second IVC 210-2 from the second port.

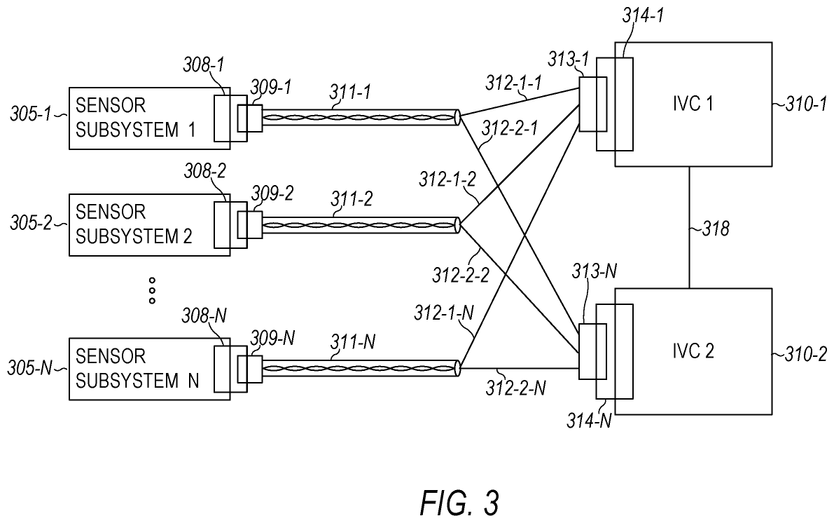

FIG. 3 illustrates an embodiment of an example of multiple sensor subsystems 305-1, 305-2, . . . 305-N coupled to both a first IVC 310-1 and a second IVC 310-2. The sensor subsystems 305-1, 305-2, . . . 305-N, the first IVC 310-1, and the second IVC 310-2 can be implemented in a manner similar to the sensor subsystem 105 and IVCs 110-1 and 110-2 of FIG. 1 or the sensor subsystem 205 and IVCs 210-1 and 210-2 of FIG. 2. The first IVC 310-1 and the second IVC 310-2 can be structured as redundant IVCs. An inter-IVC communication link 318 can be provided between the first IVC 310-1 and the second IVC 310-2. On each of the IVCs 310-1 and 310-2, one multiple-pair connector can be used to provide network communication with the N sensor subsystems 305-1, 305-2, . . . 305-N by connecting the multiple sensor subsystems via multiple splitter cables with each splitter cable connected to a respective sensor subsystem via a single dual-pair connector at the respective sensor subsystem. For example, each of the multiple sensor subsystems 305-1, 305-2, . . . 305-N can be coupled to both the first IVC 310-1 and the second IVC 310-2 by cables 311-1, 311-2, . . . 311-N, respectively. The cables 311-1, 311-2, . . . 311-N can be splitter twisted-pair cables.

The cable 311-1 can have a dual-pair mating connector 309-1 to mate with a dual pair connector 308-1 on the sensor subsystem 305-1. The cable 311-1 can contain a twisted pair 312-1-1 that couples to the first IVC 310-1 from a first port of the sensor subsystem 305-1 in the dual pair connector 308-1. The twisted pair 312-1-1 can couple to the first IVC 310-1 via a N-pair connector 313-1 from the cables 311-1, 311-2, . . . 311-N, with the N-pair connector 313-1 mated to a N-pair connector 314-1 on the first IVC 310-1. Alternatively, the N-pair connector 313-1 mated to the N-pair connector 314-1 can be a single N-pair connector on the first IVC 310-1. The cable 311-1 can also contain a twisted pair 312-2-1 that couples to the second IVC 310-2 from a second port of the sensor subsystem 305-1 in the dual pair connector 308-1. The twisted pair 312-2-1 can couple to the second IVC 310-2 via a N-pair connector 313-2 from the cables 311-1, 311-2, . . . 311-N, with the N-pair connector 313-2 mated to a N-pair connector 314-2 on the second IVC 310-2. Alternatively, the N-pair connector 313-2 mated to the N-pair connector 314-2 can be a single N-pair connector on the second IVC 310-2.

The cable 311-2 can have a dual-pair mating connector 309-2 to mate with a dual pair connector 308-2 on the sensor subsystem 305-2. The cable 311-2 can contain a twisted pair 312-1-2 that couples to the first IVC 310-1 from a first port of the sensor subsystem 305-2 in the dual pair connector 308-2. The twisted pair 312-1-2 can couple to the first IVC 310-1 via the N-pair connector 313-1 from the cables 311-1, 311-2, . . . 311-N, with the N-pair connector 313-1 mated to the N-pair connector 314-1 on the first IVC 310-1. The cable 311-2 can also contain a twisted pair 312-2-2 that couples to the second IVC 310-2 from a second port of the sensor subsystem 305-2 in the dual pair connector 308-2. The twisted pair 312-2-2 can couple to the second IVC 310-2 via the N-pair connector 313-2 from the cables 311-1, 311-2, . . . 311-N, with the N-pair connector 313-2 mated to the N-pair connector 314-2 on the second IVC 310-2.

The cable 311-N can have a dual-pair mating connector 309-N to mate with a dual pair connector 308-N on the sensor subsystem 305-N. The cable 311-N can contain a twisted pair 312-1-N that couples to the first IVC 310-1 from a first port of the sensor subsystem 305-N in the dual pair connector 308-N. The twisted pair 312-1-N can couple to the first IVC 310-1 via the N-pair connector 313-1 from the cables 311-1, 311-2, . . . 311-N, with the N-pair connector 313-1 mated to the N-pair connector 314-1 on the first IVC 310-1. The cable 311-2 can also contain a twisted pair 312-2-N that couples to the second IVC 310-2 from a second port of the sensor subsystem 305-N in the dual pair connector 308-N. The twisted pair 312-2-N can couple to the second IVC 310-2 via the N-pair connector 313-2 from the cables 311-1, 311-2, . . . 311-N, with the N-pair connector 313-2 mated to the N-pair connector 314-2 on the second IVC 310-2.

Each sensor subsystem of the multiple sensor subsystems 305-1, 305-2, . . . 305-N can be coupled to the first IVC 310-1 and the second IVC 310-2 in a similar manner. The multiple sensor subsystems 305-1, 305-2, . . . 305-N can be a combination of a number of different types of sensor subsystems. The combination can include multiple sensor subsystems of the same type. For example, the multiple sensor subsystems 305-1, 305-2, . . . 305-N can include one or more sensor subsystems selected from a camera subsystem, a radar subsystem, a lidar subsystem, a sonar subsystem, a global positioning subsystem, an inertial measurement unit subsystem, and a subsystem of a combination of a camera sensor, a radar sensor, a lidar sensor, a sonar sensor, a global positioning sensor, and an inertial measurement sensor on a same package.

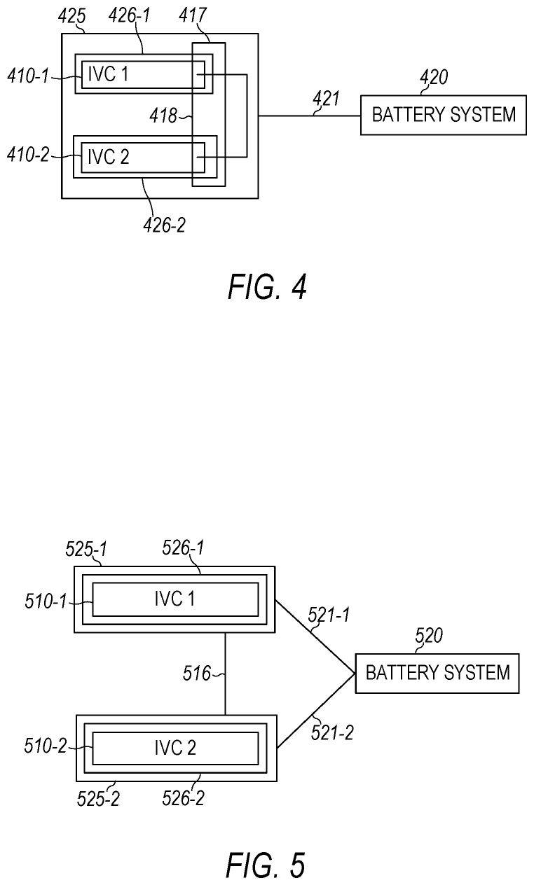

In order to reduce replacement or repair cost in case of the failure of one of two redundant IVCs, each one of the two redundant IVCs can be located on a separate PCB, or similar structure, so that one IVC can be replaced or repaired without impacting the other IVC. FIG. 4 and FIG. 5 show examples of two embodiments that locate each IVC on a separate platform and share or not share the same enclosure.

FIG. 4 illustrates an embodiment of an example of a first IVC 410-1 and a second IVC 410-2 arranged to receive power from a battery system 420. The first IVC 410-1 and the second IVC 410-2 can be configured to be capable of arrangement and operation in a similar manner to the IVCs of FIGS. 1-3. The first IVC 410-1 and a second IVC 410-2 can be housed in an enclosure 425, with the first IVC 410-1 disposed on a platform 426-1 and the second IVC 410-2 disposed on a platform 426-2. The platform 426-1 and the second IVC 410-2 can be separate from each other with both platforms coupled to a backplane 417 that receives power using a power cable 421 from the battery system 420. The platforms 426-1 and 426-2 can be PCBs or other similar structures. The first IVC 410-1 and the second IVC 410-2 can be configured as redundant IVCs. The first IVC 410-1 and the second IVC 410-2 can interact using an inter-IVC communication link 418 over the backplane 417.

FIG. 5 illustrates an embodiment of an example of a first IVC 510-1 and a second IVC 510-2 arranged to receive power from a battery system 520. The first IVC 510-1 and the second IVC 510-2 can be configured to be capable of arrangement and operation in a similar manner to the IVCs of FIGS. 1-3. The first IVC 510-1 can be housed in an enclosure 525-1 with the first IVC 510-1 disposed on a platform 526-1. The second IVC 510-2 can be housed in an enclosure 525-2 with the second IVC 510-2 disposed on a platform 526-2. The enclosure 525-1 and the enclosure 525-2 can be separate, where the first IVC 510-1 receives power from the battery system 520 via a power cable 521-1 and the second IVC 510-2 receives power from the battery system 520 via a power cable 521-2. The platforms 526-1 and 526-2 can be PCBs or other similar structures. The first IVC 510-1 and the second IVC 510-2 can be configured as redundant IVCs. The first IVC 510-1 and the second IVC 510-2 can interact using an inter-IVC communication link 516. The communication link 516 can be located on a front or a rear panel of the first IVC 510-1 and the second IVC 510-2.

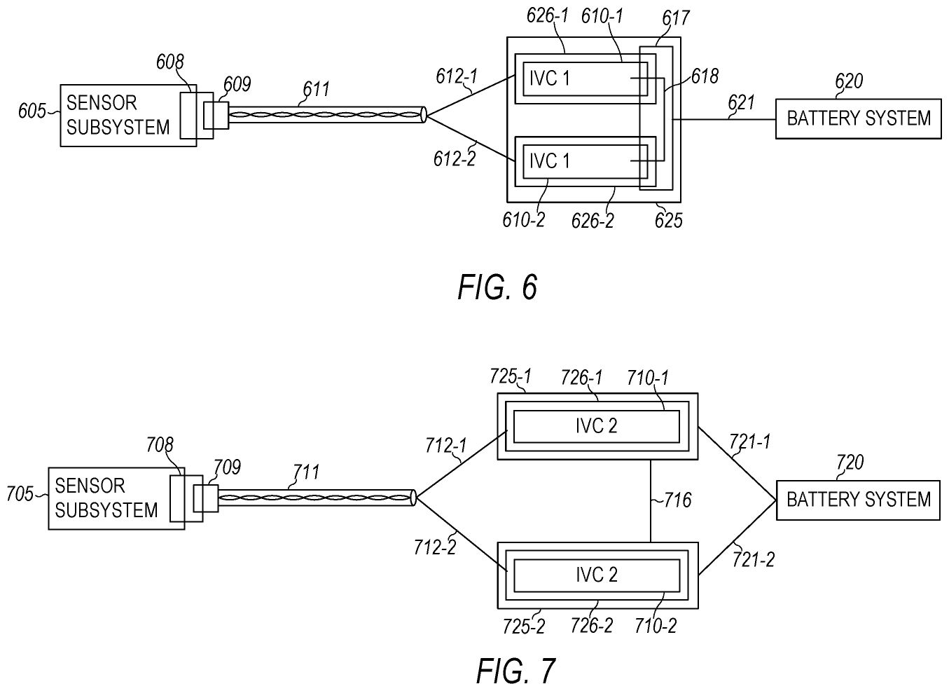

FIG. 6 illustrates an embodiment of an example sensor subsystem 605 configured with a first IVC 610-1 and a second IVC 610-2 arranged to receive power from a battery system 620. The sensor subsystem 605 is coupled to both the first IVC 610-1 and the second IVC 610-2. The sensor subsystem 605, the first IVC 610-1, the second IVC 610-2, and the battery system 620 can be configured to be capable of arrangement and operation in a similar manner to the components of FIGS. 1-4.

The sensor subsystem 605 can couple to both the first IVC 610-1 and the second IVC 610-2 via a cable 611. The cable 611 can be a splitter twisted-pair cable. The cable 611 can be dual-pair twisted-pair cable. The cable 611 can have a dual-pair mating connector 609 to mate with a dual pair connector 608 on the sensor subsystem 605. The cable 611 and the dual-pair mating connector 609 couple the first IVC 610-1 to a first port of sensor subsystem 605 in pair connector 608 such that a twisted pair 612-1 couples to the first IVC 610-1 from the first port. The cable 611 and the dual-pair mating connector 609 also couple the second IVC 610-2 to a second port of sensor subsystem 605 in pair connector 608 such that a twisted pair 612-2 couples to the second IVC 610-2 from the second port.

The first IVC 610-1 and a second IVC 610-2 are arranged to receive power from a battery system 620. The first IVC 610-1 and a second IVC 610-2 can be housed in an enclosure 625, with the first IVC 610-1 disposed on a platform 626-1 and the second IVC 610-2 disposed on a platform 626-2. The platform 626-1 and the second IVC 610-2 can be separate from each other with both platforms coupled to a backplane 617 that receives power, using a power cable 621, from the battery system 620. The platforms 626-1 and 626-2 can be PCBs or other similar structures. The first IVC 610-1 and the second IVC 610-2 can be configured as redundant IVCs. The first IVC 610-1 and the second IVC 610-2 can interact using an inter-IVC communication link 618 over the backplane 617.

FIG. 7 illustrates an embodiment of an example sensor subsystem 705 configured with a first IVC 710-1 and a second IVC 710-2 arranged to receive power from a battery system 720. The sensor subsystem 705 is coupled to both the first IVC 710-1 and the second IVC 710-2. The sensor subsystem 705, the first IVC 710-1, the second IVC 710-2, and the battery system 720 can be configured to be capable of arrangement and operation in a similar manner to the components of FIGS. 1-3 and 5.

The sensor subsystem 705 can couple to both the first IVC 710-1 and the second IVC 710-2 via a cable 711. The cable 711 can be a splitter twisted-pair cable. The cable 711 can be dual-pair twisted-pair cable. The cable 711 can have a dual-pair mating connector 709 to mate with a dual pair connector 708 on the sensor subsystem 705. The cable 711 and the dual-pair mating connector 709 couple the first IVC 710-1 to a first port of sensor subsystem 705 in pair connector 708 such that a twisted pair 712-1 couples to the first IVC 710-1 from the first port. The cable 711 and the dual-pair mating connector 709 also couple the second IVC 710-2 to a second port of sensor subsystem 705 in pair connector 708 such that a twisted pair 712-2 couples to the second IVC 710-2 from the second port.

The first IVC 710-1 can be housed in an enclosure 725-1 with the first IVC 710-1 disposed on a platform 726-1. The second IVC 710-2 can be housed in an enclosure 725-2 with the second IVC 710-2 disposed on a platform 726-2. The enclosure 725-2 and the enclosure 725-2 can be separate, where the first IVC 710-1 receives power from the battery system 720 via a power cable 721-1 and the second IVC 710-2 receives power from the battery system 720 via a power cable 721-2. The platforms 726-1 and 726-2 can be PCBs or other similar structures. The first IVC 710-1 and the second IVC 710-2 can be configured as redundant IVCs. The first IVC 710-1 and the second IVC 710-2 can interact using an inter-IVC communication link 716. The communication link 716 can be located on a front or a rear panel of the first IVC 710-1 and the second IVC 710-2.

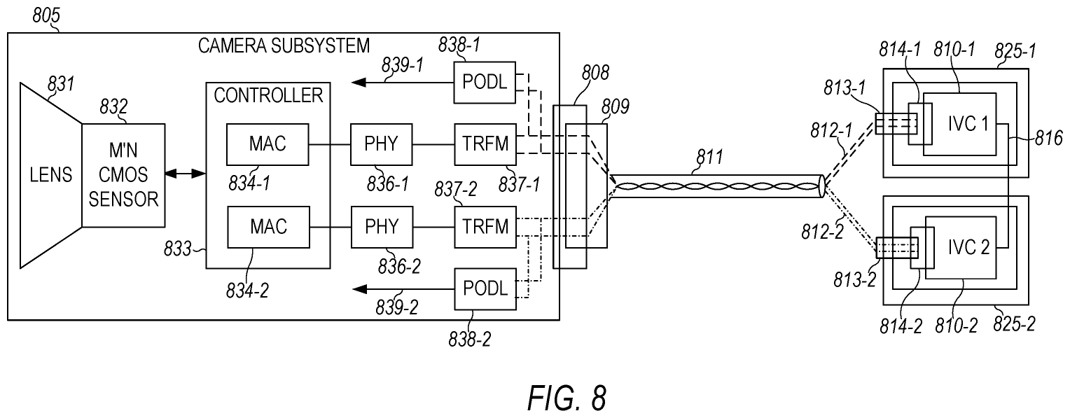

FIG. 8 illustrates an embodiment of an example camera subsystem 805 configured with a first IVC 810-1 and a second IVC 810-2. The camera subsystem 805 is coupled to both the first IVC 810-1 and the second IVC 810-2. The camera subsystem 805, the first IVC 810-1, and the second IVC 810-2 can be configured to be capable of arrangement and operation in a similar manner to features of the components of FIGS. 1-7.

The camera subsystem 805 can include a lens 831, an M*N CMOS sensor 832 coupled to the lens 831 to capture an image, and a controller 833 coupled to receive image data from the M*N CMOS sensor 832 and provide a version of the image data to a first port and to a second port of the camera subsystem 805. Sensors other than CMOS sensors can be used to receive the image data, such as but not limited to a CCD (charge coupled device) image sensor. The M*N CMOS sensor 832, or other image sensor such as a CCD image sensor, with a resolution of M*N pixels captures the image data via the lens 831, and the controller 833 receives and operates on the image data from the M*N CMOS sensor 832, or other image sensor such as a CCD image sensor to generate the version of the image data. The version of the image data can include raw image data, encoded image data, processed perception data, or a combination of raw image data, encoded image data, and processed perception data. Generation of the version of the image data can be provided by processing of the image data, which processing may include image or video compression based on an industry standard such as JPEG or H.264/H.265, or image recognization data based on artificial intelligence technologies such as but not limited to deep learning neural network inferencing. The version of the image data can be provided to a first network port and to a second network port of a dual pair connector 808 in the camera subsystem 805, in response to an instruction received from the first IVC 810-1 or the second IVC 810-2, from which the version of the image data is sent to the first IVC 810-1 and second IVC 810-2.

The camera subsystem 805 can include two sets of components coupled to the dual pair connector 808. The dual pair connector 808 from its first network port can be coupled to a transformer (TRFM) 837-1 within the camera subsystem 805, where the TRFM 837-1 is coupled to a physical layer (PHY) 836-1 that couples to a media access control (MAC) layer 834-1 of the controller 833. The dual pair connector 808 from its second network port can be coupled to a transformer (TRFM) 837-2 within the camera subsystem 805, where the TRFM 837-2 is coupled to a physical layer (PHY) 836-2 that couples to a MAC layer 834-2 of the controller 833. Optionally, power for the camera subsystem 805 can be delivered from an enclosure 825-1 containing the first IVC 810-1 via PoDL 838-1 coupled to the first network port of the dual pair connector 808 to provide DC power 839-1, and power for the camera subsystem 805 can be delivered from an enclosure 825-2 containing the second IVC 810-2 via PoDL 838-2 coupled to the second network port of the dual pair connector 808 to provide DC power 839-1.

The camera subsystem 805 can couple to both the first IVC 810-1 and the second IVC 810-2 via a cable 811. The cable 811 can be a splitter twisted-pair cable. The cable 811 can be dual-pair twisted-pair cable. The cable 811 can have a dual-pair mating connector 809 to mate with the dual pair connector 808 on the camera subsystem 805. The cable 811 can have a single-pair mating connector 813-1 that connects to a single-pair connector 814-1 on the first IVC 810-1. The single-pair connector 814-1 of the first IVC 810-1 couples the first IVC 810-1 to the first port of the camera subsystem 805 in the dual pair connector 808 such that a twisted pair 812-1 couples to the first IVC 810-1 from the first port. The cable 811 can also have a single-pair mating connector 813-2 that connects to a single-pair connector 814-2 on the second IVC 810-2. The single-pair connector 814-2 of the second IVC 810-2 couples the second IVC 810-2 to the second port of the camera subsystem 805 in pair connector 808 such that a twisted pair 812-2 couples to the second IVC 810-2 from the second port.

The first IVC 810-1 and the second IVC 810-2 can be configured as redundant IVCs. The first IVC 810-1 and the second IVC 810-2 can interact using an inter-IVC communication link 816. The communication link 816 can be located on a front or a rear panel of the first IVC 810-1 and the second IVC 810-2. Alternatively, the first IVC 810-1 and the second IVC 810-2 can be configured to the first IVC 610-1 and the second IVC 610-2 of FIG. 6.

The same dual-port network interface design methodology associated with the camera subsystem 805 can also be applied to other sensors for vehicles such as autonomous driving vehicles. Such other sensors can include radar, LiDAR, sonar, IMU, and GPS receiver, but with each sensor having its a unique sensing technology different from the lens 831 and M*N CMOS sensor 832 or other image sensor in the camera subsystem 805. In some applications, a sensor subsystem can be realized as one or more sensors without enhanced processors of the sensed data.

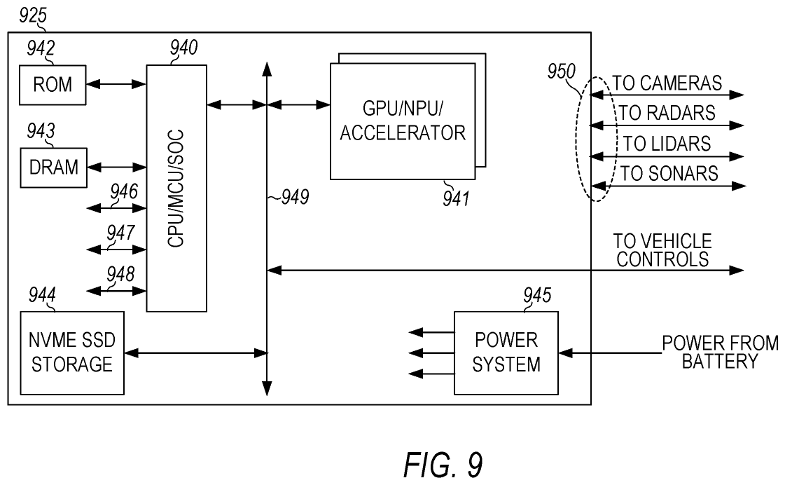

FIG. 9 illustrates an embodiment of an example IVC structure 925 that can be used for two redundant IVCs to couple to sensor subsystems, where the sensor subsystems include two ports to couple to the two redundant IVCs. The IVC structure 925 can be implemented associated with the arrangement and operation in a similar manner to features of the IVCs associated with FIGS. 1-8.

The IVC structure 925 can include a central processing unit (CPU) or microcontroller (MCU) or system on a chip (SoC) 940 for overall control functions, one or more graphics processing unit (GPU) or neural processing unit (NPU) or accelerators 941 for processing of perception data from sensors. The IVC structure 925 can couple to sensors such as cameras, radars, LiDARs, sonars, or other sensors. The CPU/MCU/SoC 940 can couple to memory structures such as a dynamic random-access memory (DRAM) 943 and a read only memory (ROM) 942. The CPU/MCU/SoC 940 can communicate with other components in the vehicle for status monitoring and vehicle control via one or more of a CAN bus/FlexRay link 946, a RS-232/485 link, and a Ethernet link 948. The CPU/MCU/SoC 940 and the one or more GPU/NPU/accelerators 941 can couple an interface 949, such as an interface using a peripheral component interconnect express (PCIe) standard or a proprietary one. The CPU/MCU/SoC 940, the one or more GPU/NPU/accelerators 941, and the interface 949 can be realized as a single SoC or a number of discrete components. The interface 949 can couple signals or data from the CPU/MCU/SoC 940 and the one or more GPU/NPU/accelerators 941 to vehicle controls and a non-volatile memory express (NVMe) solid-state drive (SSD) storage 944. The GPU/NPU/Accelerator(s) communicate with the sensors via twisted-pair single-pair Ethernet links 950. The IVC structure 925 can include a power system 945 that can receive power from a battery.

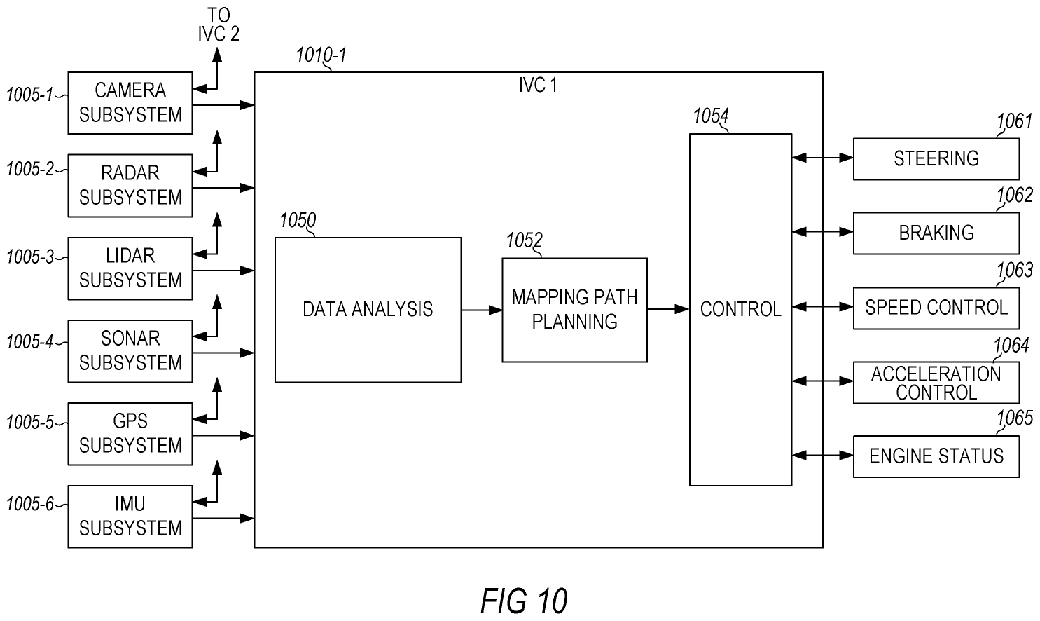

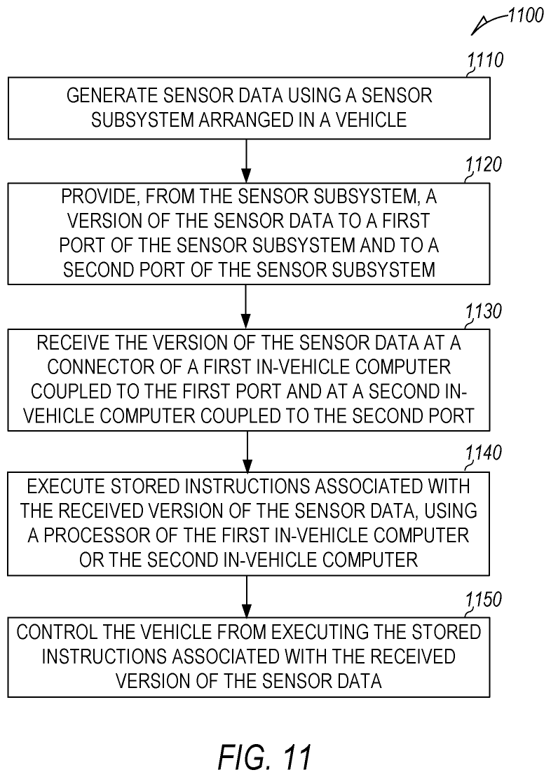

FIG. 10 is a block diagram of an embodiment of an example first IVC 1010-1 of a pair of redundant IVCs, illustrating functionality of the IVCs implemented in an autonomous vehicle. The first IVC 1010-1 can be coupled to one or more of a camera subsystem 1005-1, a radar subsystem 1005-2, a LiDAR subsystem 1005-3, a sonar subsystem 1005-4, a GPS subsystem 1005-5, and a IMU subsystem 1005-6. The connection to one or more of these sensor subsystems can be via a first network port of the respective sensor subsystem with a second network port of the respective sensor subsystem coupled to a second IVC of the pair of redundant IVCs.

The functionality of the first IVC 1010-1 can include data analysis 1050, which can be implemented by a processor of the first IVC 1010-1 and associated memory. The data analysis 1050 can include DNNs for driving, obstacle perception, path perception, wait perception, and data fusion. data fusion provides for integrating multiple data sources to produce more consistent and accurate data than that provided by any individual source. The data analysis 1050 uses data received from one or more of the camera subsystem 1005-1, the radar subsystem 1005-2, the LiDAR subsystem 1005-3, the sonar subsystem 1005-4, the GPS subsystem 1005-5, and the IMU subsystem 1005-6. Results of the data analysis 1050 can be used for mapping an environment of the autonomous vehicle and path planning for operation of the autonomous vehicle. Results of the mapping and path planning 1052 can be used for control 1054. The control 1054 can direct various functions of the autonomous vehicle, which can include steering 1061, braking 1062, speed control 1063, acceleration control 1064, and engine status 1065. The two novel network ports of these sensor subsystems for an autonomous driving vehicle with each network port connected to one of the two redundant IVCs for sensor control, configuration, status, and data communications between these sensor subsystems and the two redundant IVC provides enhancement in reliability and reduction in replacement or repair costs.

FIG. 11 is a flow diagram of features of an embodiment of an example method 1100 of operating a vehicle. At 1110, sensor data is generated using a sensor subsystem arranged in a vehicle. At 1120, a version of the sensor data is provided, from the sensor subsystem, to a first port of the sensor subsystem and to a second port of the sensor subsystem. At 1130, the version of the sensor data is received at a first in-vehicle computer coupled to the first port and at a second in-vehicle computer coupled to the second port. At 1140. stored instructions associated with the received version of the sensor data are executed, using a processor of the first in-vehicle computer or the second in-vehicle computer. At 1150, the vehicle is controlled from executing the stored instructions associated with the received version of the sensor data.

Variations of the method 1100 or methods similar to the method 1100 can include a number of different embodiments that may be combined depending on the application of such methods and/or the architecture of memory devices in which such methods are implemented. Such methods can include providing power to the sensor subsystem via a splitter cable coupling a connector of the first in-vehicle computer and a connector of the second in-vehicle computer to a dual-pair connector containing the first port and the second port, where the splitter cable and the sensor subsystem are operable with Power-over-Data-Line (PoDL) support. Variations of the method 1100 or methods similar to the method 1100 can include the first in-vehicle computer and the second in-vehicle computer being replaceable independent of each other.

In various embodiments, a system can be implemented to operate in a vehicle. The vehicle can be an autonomous driving vehicle. Such a system can comprise a sensor subsystem capable of being arranged in a vehicle. A first port of the sensor subsystem can be structured to couple to a first in-vehicle computer, with the sensor subsystem separate from a first enclosure of the first in-vehicle computer. A second port of the sensor subsystem can be structured to couple to a second in-vehicle computer, with the sensor subsystem separate from a second enclosure of the second in-vehicle computer. The first port and the second port can be coupled to a dual-pair connector of the sensor subsystem with the dual-pair connector to couple to the first in-vehicle computer and to the second in-vehicle computer.

Variations of such a system or similar systems can include a number of different embodiments that may be combined depending on the application of such systems and/or the architecture in which such systems are implemented. Such systems can include the sensor subsystem being a camera subsystem. The camera subsystem can include a lens, a sensor coupled to the lens to capture an image, and a controller. The controller can be coupled to receive image data from the sensor and provide a version of the image data to the first port and to the second port. The version of the image data can include raw image data, encoded image data, processed perception data, or a combination of raw image data, encoded image data, and processed perception data. The version of the image data can be provided to the first port and to the second port in response to an instruction received from the first in-vehicle computer or the second in-vehicle computer.

Variations of such systems can include the first port and the second port being twisted-pair SPE ports with the first port structured to connect to the first in-vehicle computer to provide communication of control, configuration, status, and data transfers between the sensor subsystem and the first in-vehicle computer; and with the second port structured to connect to the second in-vehicle computer to provide communication of control, configuration, status, and data transfers between the sensor subsystem and the second in-vehicle computer. Each of the first port and the second port can be structured to connect to a single-pair Ethernet link with Power-over-Data-Line support. The system can include the first in-vehicle computer having a first cable connector to couple to the first port and the second in-vehicle computer having a second cable connector to couple to the second port.

In various embodiments, a system can be implemented to operate in a vehicle. The vehicle can be an autonomous driving vehicle. The system can include a sensor subsystem, a first in-vehicle computer, a second in-vehicle computer. The sensor subsystem can have a first port and a second port. The first in-vehicle computer can be coupled to the first port with the first in-vehicle computer disposed on a first circuit board. The second in-vehicle computer can be coupled to the second port with the second in-vehicle computer disposed on a second circuit board, where the first circuit board is separate from the second circuit board. The can include a communication link between the first in-vehicle computer and the second in-vehicle computer.

Variations of such a system or similar systems can include a number of different embodiments that may be combined depending on the application of such systems and/or the architecture in which such systems are implemented. Such systems can include an enclosure housing the first in-vehicle computer and the second in-vehicle computer, with power distributed to the first in-vehicle computer and the second in-vehicle computer via a backplane connectable to a battery system of a vehicle.

Variations of such a system or similar systems can include the system having a dual-pair connector of the sensor subsystem containing the first port and the second port and a splitter cable coupled to the dual-pair connector, to a first connector of the first in-vehicle computer; and to a second connector of the second in-vehicle computer. The first port and the second port can be realized as twisted-pair single-port Ethernet ports with the first port structured to connect to the first in-vehicle computer to provide communication of control, configuration, status, and data transfers between the sensor subsystem and the first in-vehicle computer, and with the second port structured to connect to the second in-vehicle computer to provide communication of control, configuration, status, and data transfers between the sensor subsystem and the second in-vehicle computer.

Variations of such a system or similar systems can include the sensor subsystem being one of a camera subsystem, a radar subsystem, a lidar subsystem, a sonar subsystem, a global positioning subsystem, an inertial measurement unit subsystem, and a subsystem of a combination of a camera sensor, a radar sensor, a lidar sensor, a sonar sensor, a global positioning sensor, and an inertial measurement sensor on a same package. Variations of such a system or similar systems can include the first in-vehicle computer being coupled to first ports of one or more additional sensor subsystems and the second in-vehicle computer being coupled to second ports of the one or more additional sensor subsystems.

Variations of such a system or similar systems can include each of the first in-vehicle computer and the second in-vehicle computer to include a memory storing instructions and data; and one or more processors in communication with the memory, such that the one or more processors execute the instructions to control an autonomous vehicle. The system can be an autonomous vehicle.

In various embodiments, a novel sensor subsystem design with two network ports for communications with two redundant IVCs can be implemented to enable separate but redundant interconnection paths between a sensor subsystem and the two redundant IVCs to reduce single-point failure for higher RAS performance. This design can also be used to eliminate the data replication by the sensor subsystem between the two redundant IVCs. The two network ports on the sensor subsystem can share one dual-pair connector. For example, a sensor subsystem can use a single dual-pair connector and a splitter cable for connection with the two redundant IVCs, where a connector on each IVC can be a single-pair or a dual-Pair connector, and a Ethernet link between the sensor subsystem and the IVCs can be implemented that adopts IEEE 802.3bh or IEEE 802.3ch a single-pair-Ethernet (SPE) standard with or without PoDL support. Other connection links can be used between the sensor subsystem and the IVCs. If PoDL support is not used, power can be provided to the sensor subsystem via a separate cable. In addition, each of the two redundant IVC can be disposed on a separate platform, such as a PCB, where the two IVCs can share the same enclosure or each can have its own enclosure. The design with separate platforms for the IVCs can be implemented to enable modular IVC system design, can allow for lower vehicle repair and replacement cost than integrated redundant IVC designs.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. The above description is intended to be illustrative, and not restrictive, and the phraseology or terminology employed herein is for the purpose of description. Combinations of the above embodiments and other embodiments will be apparent to those of skill in the art upon studying the above description.

What is claimed as:

1. A system for a vehicle, the system comprising:
a sensor subsystem capable of being arranged in a vehicle;
a first port of the sensor subsystem structured to couple to a first in-vehicle computer, with the sensor subsystem separate from a first enclosure of the first in-vehicle computer; and
a second port of the sensor subsystem structured to couple to a second in-vehicle computer, with the sensor subsystem separate from a second enclosure of the second in-vehicle computer.

2. The system of claim 1, wherein the first port and the second port are coupled to a dual-pair connector of the sensor subsystem with the dual-pair connector to couple to the first in-vehicle computer and to the second in-vehicle computer.

3. The system of claim 1, wherein the sensor subsystem is a camera subsystem including:
a lens;
a sensor coupled to the lens to capture an image; and
a controller coupled to receive image data from the sensor and provide a version of the image data to the first port and to the second port.

4. The system of claim 3, wherein the version of the image data includes raw image data, encoded image data, processed perception data, or a combination of raw image data, encoded image data, and processed perception data.

5. The system of claim 3, wherein the version of the image data is provided to the first port and to the second port in response to an instruction received from the first in-vehicle computer or the second in-vehicle computer.

6. The system of claim 1, wherein the first port and the second port are twisted-pair single-pair Ethernet (SPE) ports with the first port structured to connect to the first in-vehicle computer to provide communication of control, configuration, status, and data transfers between the sensor subsystem and the first in-vehicle computer; and with the second port structured to connect to the second in-vehicle computer to provide communication of control, configuration, status, and data transfers between the sensor subsystem and the second in-vehicle computer.

7. The system of claim 6, wherein each of the first port and the second port is structured to connect to a SPE link with Power-over-Data-Line support.

8. The system of claim 6, wherein the system includes:
the first in-vehicle computer having a first cable connector to couple to the first port; and
the second in-vehicle computer having a second cable connector to couple to the second port.

9. A system for a vehicle, the system comprising:
a sensor subsystem having a first port and a second port;
a first in-vehicle computer coupled to the first port with the first in-vehicle computer disposed on a first circuit board; and
a second in-vehicle computer coupled to the second port with the second in-vehicle computer disposed on a second circuit board, the first circuit board being separate from the second circuit board.

10. The system of claim 9, wherein the system includes a communication link between the first in-vehicle computer and the second in-vehicle computer.

11. The system of claim 9, wherein the system includes an enclosure housing the first in-vehicle computer and the second in-vehicle computer, with power distributed to the first in-vehicle computer and the second in-vehicle computer via a backplane connectable to a battery system of a vehicle.

12. The system of claim 9, wherein the system includes:
a dual-pair connector of the sensor subsystem containing the first port and the second port; and
a splitter cable coupled to the dual-pair connector, to a first connector of the first in-vehicle computer; and to a second connector of the second in-vehicle computer.

13. The system of claim 9, wherein the first port and the second port are twisted-pair single-port Ethernet ports with the first port structured to connect to the first in-vehicle computer to provide communication of control, configuration, status, and data transfers between the sensor subsystem and the first in-vehicle computer; and with the second port structured to connect to the second in-vehicle computer to provide communication of control, configuration, status, and data transfers between the sensor subsystem and the second in-vehicle computer.

14. The system of claim 9, wherein the sensor subsystem is one of a camera subsystem, a radar subsystem, a lidar subsystem, a sonar subsystem, a global positioning subsystem, an inertial measurement unit subsystem, and a subsystem of a combination of a camera sensor, a radar sensor, a lidar sensor, a sonar sensor, a global positioning sensor, and an inertial measurement sensor on a same package.

15. The system of claim 9, wherein the first in-vehicle computer is coupled to first ports of one or more additional sensor subsystems and the second in-vehicle computer is coupled to second ports of the one or more additional sensor subsystems.

16. The system of claim 9, wherein each of the first in-vehicle computer and the second in-vehicle computer includes:
a memory storing instructions and data; and
one or more processors in communication with the memory, wherein the one or more processors execute the instructions to control an autonomous vehicle.

17. The system of claim 9, wherein the system is an autonomous vehicle.

18. A method of operating a vehicle, the method comprising:
generating sensor data using a sensor subsystem arranged in a vehicle;
providing, from the sensor subsystem, a version of the sensor data to a first port of the sensor subsystem and to a second port of the sensor subsystem;
receiving the version of the sensor data at a first in-vehicle computer coupled to the first port and at a second in-vehicle computer coupled to the second port;
executing stored instructions associated with the received version of the sensor data, using a processor of the first in-vehicle computer or the second in-vehicle computer; and
controlling the vehicle from executing the stored instructions associated with the received version of the sensor data.

19. The method of claim 18, wherein the method includes providing power to the sensor subsystem via a splitter cable coupling a connector of the first in-vehicle computer and a connector of the second in-vehicle computer to a dual-pair connector containing the first port and the second port, the splitter cable and the sensor subsystem operable with Power-over-Data-Line (PoDL) support.

20. The method of claim 18, wherein the first in-vehicle computer and the second in-vehicle computer are replaceable independent of each other.
